(19) United States
(12) Patent Application Publication
(10) Pub. No.: US 2017/0220529 A1
(43) Pub. Date: Aug. 3, 2017

(54) DATA PROCESSING SYSTEM, DATA EMBEDDING DEVICE AND DATA EMBEDDING PROGRAM

(71) Applicant: WingArc1st Inc., Tokyo (JP)

(72) Inventors: Ko SHIMAZAWA, Tokyo (JP); Yasuhiro KAWASE, Tokyo (JP)

(21) Appl. No.: 15/384,763

(22) Filed: Dec. 20, 2016

(30) Foreign Application Priority Data
Jan. 29, 2016 (JP) 2016-015194

(51) Int. Cl. G06F 17/22; G06F 17/21; G06F 17/30

(52) U.S. Cl. CPC G06F 17/2205; G06F 17/30091; G06F 17/211

(57) ABSTRACT

There are provided a tag presence deciding unit 21 for reading a save file of a document created by a specific application from a file storing unit 11 and opening the save vile, and deciding whether an embedding tag is present in the document or not, a data acquiring unit 22 for acquiring data for embedding which is stored in the file storing unit 11 in association with the embedding tag if the embedding tag is present, and a data embedding unit 23 for embedding the acquired data for embedding to perform file saving again, and the data for embedding is embedded automatically into a position of the embedding tag so that the file of the document is updated and saved if the file saving is performed in a state in which the embedding tag is inserted into the document.

### BACKGROUND OF THE INVENTION

### Field of the Invention

The present invention relates to a data processing system, a data embedding device and a data embedding program, and more particularly, is suitably used in a system for performing a data processing to embed, into a document created by a specific application, data created by another application.

### Description of the Related Art

Conventionally, there is known the technique for embedding, into a document created by a specific application, data created by another application. For example, it is possible to embed a chart or a graph created in spreadsheet software into a document created in document creating software, presentation software or the like. An add-in method is generally used for such data embedding.

There is published the technique for embedding a line graph of a measured value to create a report file for presentation software (for example, see Patent Document 1). Referring to the automatic report system described in the Patent Document 1, after measured value to be output by a measuring apparatus is stored in a database, a table tilled out with a measured value in time order or a line graph indicative of a time change in a measured value is embedded in a document file to be opened in spreadsheet software or the like so that a report file is created.
[Patent Document 1] Japanese Laid-Open Patent Publication No. 2012-208740

### DISCLOSURE OF THE INVENTION

As described above, the operation for embedding, into a document created by a specific application, data created by another application is generally implemented by an add-in function. For this reason, there is a problem in that it is necessary to previously incorporate a small program for add-in into an application of a document which should be subjected to embedding.

The present invention has been made to solve the problem and has an object to enable data created by another application to be embedded without incorporating a small program for add-in into a specific application.

order to solve the problem described above, in the present invention, a save file of a document created by a specific application is read from a file storing unit and is opened, and it is decided whether an embedding tag is present in the document or not. If it is decided that the embedding tag is present, data for embedding stored in a file storing unit in association with the embedding tag is embedded in a position where the embedding tag is present and the document subjected to the data embedding is re-saved as a file in the file storing unit.

According to the present invention having the structure described above, if a file is saved in a state in which an embedding tag inserted in a document created by a specific application, the saved file is then opened automatically and data for embedding created by another application is embedded into the position of the embedding tag so that the file of the document is updated and saved. Consequently, it is possible to embed the data created by the another application without incorporating a small program for add-in into the specific application.

### BRIEF DESCRIPTION OF THE DRAWINGS

FIGS. 1A to 1C are diagrams showing examples of a whole structure of a data processing system according to the present embodiment;

FIG. 2 is a block diagram showing an example of functional structures of a data generating server and a relay server according to the present embodiment;

FIG. 3 is a table showing an example of association information to be stored in an association storing unit according to the present embodiment;

FIGS. 4A and 4B are diagrams for explaining a processing content of the relay server according to the present embodiment; and

FIG. 5 is a flowchart showing an example of an operation of the relay server (a data embedding device) according to the present embodiment.

### DETAILED DESCRIPTION OF THE PREFERRED EMBODIMENTS

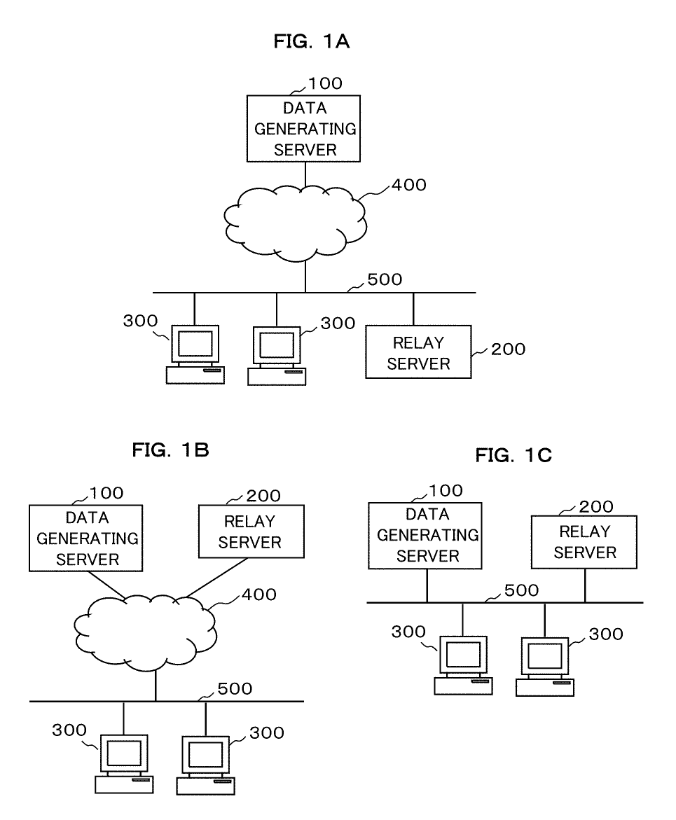

An embodiment according to the present invention will be described below with reference to the drawings. FIGS. 1A to 1C are diagrams showing examples of a whole structure of a data processing system according to the present embodiment. For example, as shown in FIG. 1A, the data processing system according to the present embodiment includes a data generating server 100 connected onto an INTERNET 400 and a relay server 200 connected onto a LAN (Local Area Network) 500 linked to the INTERNET 400. The relay server 200 corresponds to a data embedding device according to the present invention.

User terminals 300 to be used by a user are also connected to the LAN 500. The user operates the user terminal 300 to give access to the data generating server 100 through the INTERNET 400, thereby enabling a desirable document to be created by a desirable application and the desirable document to be saved in the data generating server 100. The desirable application is optional, for example, may be document creating software, spreadsheet software, drawing software, presentation software or the like.

The data generating server 100 and the relay server 200 performs a data processing in cooperation with each other. The relay server 200 performs a data processing for embedding data created by another application into a document created by a specific application and saved in the data generating server 100. Herein, the specific application and another application are formed by a combination of two of the document creating software, the spreadsheet software, the drawing software, the presentation software and the like.

For example, the specific application can be set to be the presentation software and another application can be set to be the spreadsheet software. Specifically, the relay server 200 performs a processing for embedding data such as a chart or a graph created by the spreadsheet software into the document created by the presentation software and saved in the data generating server 100.

The arrangement and structure of the server is not restricted to the example of FIG. 1A. For example, the data generating server 100 and the relay server 200 may be connected to the INTERNET 400 as shown in FIG. 1B. Alternatively, the data generating server 100 and the relay server 200 may be connected onto the LAN 500 as shown in FIG. 1C.

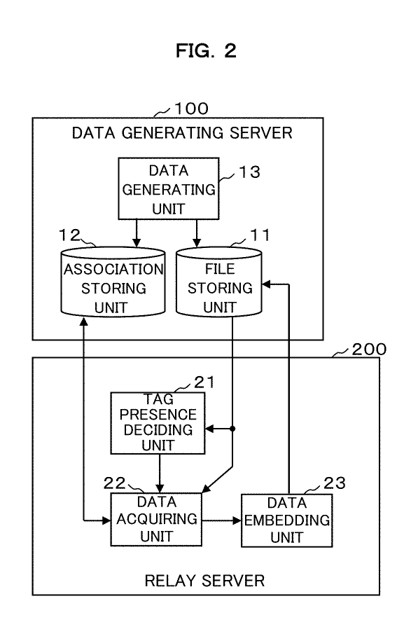

FIG. 2 is a block diagram showing an example of functional structures of the data generating server 100 and the relay server 200 according to the present embodiment. As shown in FIG. 2, the data generating server 100 includes a file storing unit 11, an association storing unit 12 and a data generating unit 13. Moreover, the relay server 200 includes a tag presence deciding unit 21, a data acquiring unit 22 and a data embedding unit 23.

The respective functional blocks 21 to 23 of the relay server 200 can be configured from any of hardware, a DSP (Digital Signal Processor) and software. For example, in the case in which they are configured from the software, the respective functional blocks 21 to 23 actually include a CPU, an RAM, an ROM and the like of a computer and are implemented by an operation of a program stored in a recording medium such as an RAM, an ROM, a hard disk or a semiconductor memory.

The file storing unit 11 stores a save file of a document created by a specification application and a save file of data for embedding which is created by another application. For example, the file storing unit 11 stores a save file of a document created by the presentation software and a save file of data for embedding such as a chart, a graph or the like which is created by the spreadsheet software. These files are generated by the data generating unit 13 based on a user operation to be performed by giving access to the data generating server 100 through the user terminal 300.

The association storing unit 12 stores association information of an embedding tag in a predetermined format and data for embedding. The format of the embedding tag can be determined optionally. For example, the format can be set to be ${- - - }. “- - - ” portion in { } can be set to be optional information such as a save file name of data for embedding or predetermined identification information.

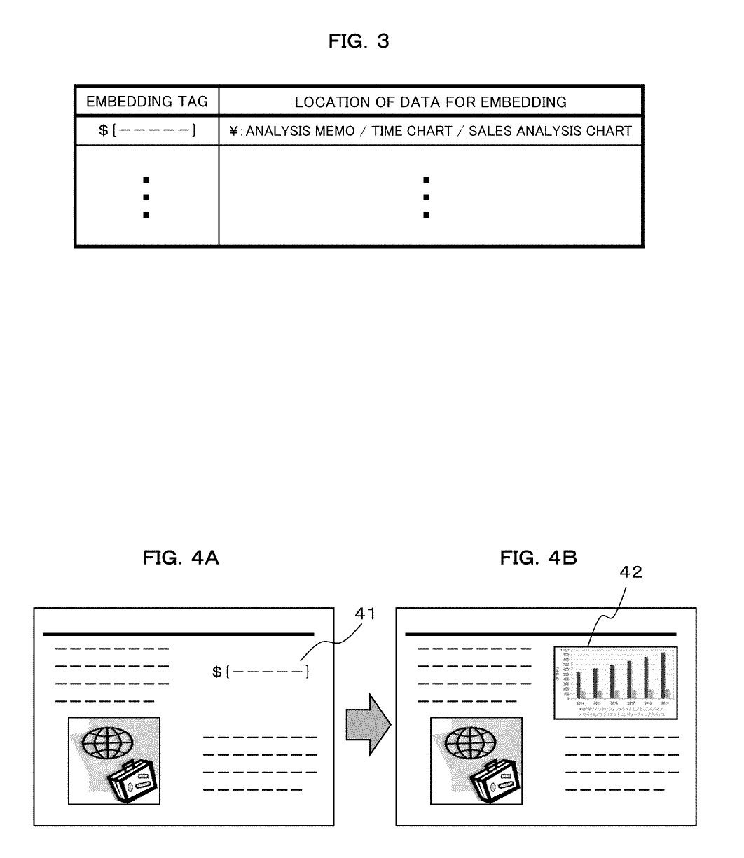

FIG. 3 is a table showing an example of the association information to be stored in the association storing unit 12. As shown in FIG. 3, the association storing unit 12 stores, as the association information, table information in which an embedding tag is associated with location information representing a place where the data for embedding are saved.

The association information is also generated by the data generating unit 13 based on the user operation to be performed by giving access to the data generating server 100 from the user terminal 300. For example, a user can generate association information and store the association information in the association storing unit 12 by performing an operation for optionally describing an embedding tag through the user terminal 300 and designating and saving a save file of data for embedding associated therewith through a well-known file system.

The tag presence deciding unit 21 reads the save file of the document stored in the file storing unit 11 from the file storing unit 11 and opens the save file, and decides whether the embedding tag is present in the document or not. For example, the tag presence deciding unit 21 periodically gives access to the file storing unit 11 and opens one or more save files of documents stored in the file storing unit 1 one by one, thereby confirming whether embedding tags are present in the documents or not, respectively.

A timing for opening a save file to decide the presence of an embedding tag is not restricted to the example described above. For example, when the data generating unit 13 saves a document file in the file storing unit 11, the data generating unit 13 gives the tag presence deciding unit 21 a notice of the save. The tag presence deciding unit 21 may open the save files of the document related to each notice and decide the presence of an embedding tag every receipt of the notice.

If it is decided by the tag presence deciding unit 21 that the embedding tag is present, the data acquiring unit 22 acquires data for embedding related to the embedding tag present in the document from the file storing unit 11 by referring to the association information stored in the association storing unit 12.

The data embedding unit 23 embeds the data for embedding acquired by the data acquiring unit 22 into a position where the embedding tag is present and resaves, as a file, a document subjected to data embedding in the file storing unit 11.

FIGS. 4A and 4B are diagrams for explaining the processing content of the relay server 200. FIG. 4A shows a certain page present in the document generated by the data generating unit 13 and stored in the file storing unit 11. A text sentence is described and an image is inserted in the page, and furthermore, an embedding tag 41 is described in a right and upper part of the page.

After this document file is saved in the file storing unit 11, the tag presence deciding unit 21 opens the save file of the document and confirms all of pages, and decides whether an embedding tag is present in the document or not. In an example of FIG. 4A, an embedding tag 41 is present. For this reason, the data acquiring unit 22 acquires data for embedding associated with the embedding tag 41 from the file storing unit 11.

Then, the data embedding unit 23 embeds the data for embedding acquired by the data acquiring unit 22 into a position where the embedding tag 41 is present. FIG. 4B shows a state in which data for embedding 42 is embedded into a position where the embedding tag 41 is present. In an example of FIG. 4B, data of a chart is embedded as the data for embedding 42. The data embedding unit 23 resaves, as a file in the file storing unit 11, a document having the data for embedding 42 embedded as shown in FIG. 4B.

When the user saves a document created by description of the embedding tag 41 as shown in FIG. 4A in the file storing unit 11 and then opens a save file of the document again, accordingly, there is made a change into a state in which a chart of the data for embedding 42 is embedded as shown in FIG. 4B.

A size of the chart to be embedded can be set to be a predetermined size. In the case in which the chart is embedded in the predetermined size into a document, a layout in a page is not always proper (as is desired by the user). In this case, the user preferably regulates the layout optionally when operating the user terminal 300 and subsequently opening the document. Although the explanation has been given to the example in which the chart is embedded as the data for embedding, the case in which data in another format such as an image or a graphic are to be embedded is the same, and the data is embedded to have a predetermined size into the document.

In the case in which the data for embedding is embedded in the document, the embedding tag may be deleted from the document or be left in a state in which it is invisible. In the case in which the embedding tag is left in the document, the data for embedding to be embedded can be maintained in the newest condition with a structure in which the tag presence deciding unit 21 periodically decides the presence of the embedding tag in the document if any.

In other words, if the user operates the user terminal 300 to update the data for embedding in the file storing unit 11 and saves the updated data for embedding as a file in the file storing unit 11, the updated data for embedding is embedded into the position of the embedding tag in a next periodic timing to the decision of the presence of the embedding tag which is made by the tag presence deciding unit 21. When the user opens the document, consequently, there is brought a state in which the newest data for embedding is always embedded.

When the tag presence deciding unit 21 opens the save file of the document to confirm the presence of the embedding tag, the data embedding unit 23 deletes the data for embedding which has already been embedded and re-embeds, into the position of the embedding tag, the data for embedding which are acquired from the file storing unit 11 by the data acquiring unit 22 at that time and saves the data for embedding if the data for embedding has already been embedded in the position of the embedding tag.

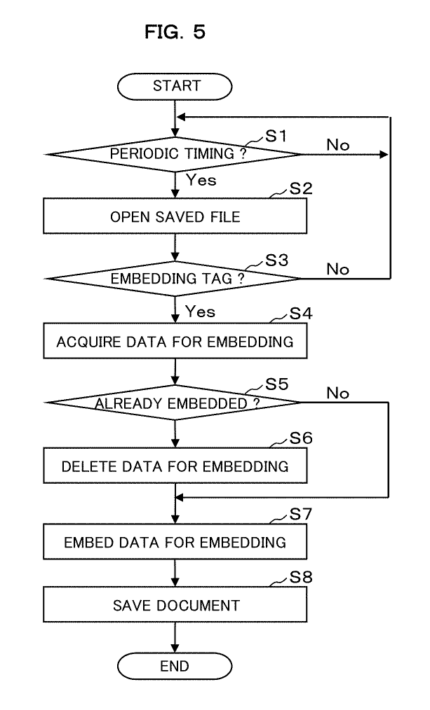

FIG. 5 is a flowchart showing an example of an operation of the relay server 200 (the data embedding device) according to the preset embodiment having the structure described above. First of all, the tag presence deciding unit 21 decides whether a periodic timing for giving access to the file storing unit 11 of the data generating server 100 arrives or not (Step S1). If the periodic timing does not arrive, the decision of Step S1 is repeated.

On the other hand, if the periodic timing arrives, the tag presence deciding unit 21 reads a save file of a document stored in the file storing unit 11 from the file storing unit 11 and opens the read file (Step S2) and confirms whether an embedding tag is present in the document or not (Step S3). If the embedding tag is not present in the document, the processing returns to Step S1.

On the other hand, if the embedding tag is present in the document, the data acquiring unit 22 acquires, from the file storing unit 11, data for embedding which is associated with the embedding tag present in the document by referring to the association information stored in the association information stored in the association storing unit 12 (Step S4).

Next, the data embedding unit 23 decides whether the data for embedding has already been embedded in the position of the embedding tag or not (Step S5). If the data for embedding has not been embedded yet, the processing makes a transition to Step S7. On the other hand, if the data for embedding have already been embedded, the data embedding unit 23 deletes the data for embedding (Step S6).

Then, the data embedding unit 23 embeds the data for embedding which is acquired by the data acquiring unit 22 in Step S4 into the position where the embedding tag is present (Step S7) and re-saves, as a file, a document subjected to the data embedding in the file storing unit 11 (Step S8). Consequently, the processing of the flowchart shown in FIG. 5 is ended.

As described above in detail, in the present embodiment, a save file of a document created by a specific application is read from the file storing unit 11 and is then opened and it is decided whether an embedding tag is present in the document or not. If it is decided that the embedding tag is present, the data for embedding stored in the file storing unit 11 in association with the embedding tag is embedded into the position where the embedding tag is present and the document subjected to the data embedding is re-saved as a file in the file storing unit 11.

According to the present embodiment having the structure described above, if file saving is performed in a state in which an embedding tag is inserted in a document created by a specific application, data for embedding which is created by another application is embedded into the position of the embedding tag so that the file of the document is updated and saved. Consequently, it is possible to embed the data created by the another application without incorporating a small program for add-in into the specific application.

Although the explanation has been given to the example in which the table information illustrated in FIG. 3 is prestored as association information in the association storing unit 12 and the data for embedding is acquired from the file storing unit 11 by referring to the association information in the embodiment, the present invention is not restricted thereto. For example, it is also possible to describe the location information in { } of the embedding tag ${- - - } so as to give access to the file storing unit 11 based on location information in an embedding tag, thereby acquiring the data for embedding.

Although the explanation has been given to the example in which the size of the data for embedding (a chart, an image, a graphic or the like) to be embedded into a document are set to have a predetermined size in the embodiment, moreover, the present invention is not restricted thereto. For example, it is also possible to designate the size of the data for embedding by describing size information in { } of the embedding tag ${- - - } Furthermore, it is also possible to designate the embedding position of the data for embedding by describing the position information in { }. The embedding position in this case can be set to be information for designating any part of the data for embedding (a center, any of four corners or the like) which is to be adjusted to the position of the embedding tag.

Although the explanation has been given to the structure in which two servers, that is, the data generating server 100 and the relay server 200 are provided in the embodiment, furthermore, the present invention is not restricted thereto. For example, it is also possible to employ a structure including a single server by causing the data generating server 100 to have the function of the relay server 200. Alternatively, it is also possible to employ a structure of a stand-alone type in place of a system structure of a client-server type. In this case, it is possible to mount the functions of the data generating server 100 and the relay server 200 on a personal computer, for example.

Although the explanation has been given to the example in which the file of the document and that of the data for embedding are stored in the same file storing unit 11 in the embodiment, moreover, these files may be stored in separate storing units. In this case, the file of the document and that of the data for embedding may be managed by separate servers.

In addition, the embodiment is only illustrative for concreteness to carry out the present invention and the technical scope of the present invention should not be thereby construed to be restrictive. In other words, the present invention can be carried out in various configurations without departing from the gist or main features thereof.

1. A data processing system for performing a data processing to embed, into a document created by a specific application, data created by another application, the system comprising:
a file storing unit for storing a save file of the document created by the specific application and a save file of data for embedding which is created by the another application;
a tag presence deciding unit for reading the save file of the document stored in the file storing unit from the file storing unit and opening the save file, and deciding whether an embedding tag is present in the document or not;
a data acquiring unit for acquiring the data for embedding which is associated with the embedding tag if it is decided by the tag presence deciding unit that the embedding tag is present; and
a data embedding unit for embedding the data for embedding which is acquired by the data acquiring unit into a position where the embedding tag is present and saving the document subjected to the data embedding as a file in the file storing unit.

2. The data processing system according to claim 1, wherein
the data embedding unit leaves an original embedding tag in an invisible condition if the data for embedding is embedded in the document, and
the tag presence deciding unit periodically decides presence of the embedding tag in the document.

3. The data processing system according to claim 1, wherein
location information indicative of a place where the data for embedding is present is described in the embedding tag, and
the data acquiring unit acquires the data for embedding based on the location information described in the embedding tag.

4. The data processing system according to claim 1, wherein
designation information for designating at least one of a size and a position of the data for embedding in embedding of the data for embedding into the document is described in the embedding tag, and
the data embedding unit embeds the data for embedding into the document based on the designation information described in the embedding tag.

5. The data processing system according to claim 1 comprising:
a data generating server and a relay server,
wherein;
the data generating server includes the association storing unit and the file storing unit, and
the relay server includes the tag presence deciding unit, the data acquiring unit and the data embedding unit.

6. A data embedding device for performing a processing to embed, into a document created by a specific application, data created by another application, the device comprising:
a tag presence deciding unit for reading a save file of a document created by the specific application from a file storing unit and opening the save file, and deciding whether an embedding tag is present in the document or not;
a data acquiring unit for acquiring data for embedding which is stored in association with the embedding tag if it is decided by the tag presence deciding unit that the embedding tag is present; and
a data embedding unit for embedding the data for embedding which is acquired by the data acquiring unit into a position where the embedding tag is present and saving the document subjected to the data embedding as a file in the file storing unit.

7. A data embedding program recorded in a non-transitory computer-readable medium for performing a processing to embed, into a document created by a specific application, data created by another application, the program causing a computer to function as:
tag presence deciding means for reading a save file of a document created by the specific application from a file storing unit and opening the save file, and deciding whether an embedding tag is present in the document or not;
data acquiring means for acquiring data for embedding which is stored in association with the embedding tag if it is decided by the tag presence deciding means that the embedding tag is present; and
data embedding means for embedding the data for embedding which is acquired by the data acquiring means into a position where the embedding tag is present and saving the document subjected to the data embedding as a file in the file storing unit.
